(19) United States
(12) Patent Application Publication
(10) Pub. No.: US 2002/0149165 A1
(43) Pub. Date: Oct. 17, 2002

(54) Scooter having a spring cushioning device

(76) Inventor: Michael Lin, Taipei (TW)

Correspondence Address: CHARLES E. BAXLEY, 5th Floor, 59 John Street, New York, NY, 10038, US

(21) Appl. No.: 09/832,368

(22) Filed: Apr. 12, 2001

(51) Int. Cl. B62B 7/00

(52) U.S. Cl. 280/87.041

(57) ABSTRACT

A scooter includes one or more wheels attached to the rear portion of a board, and a shaft rotatably secured to the front portion of the board for supporting one or more front wheels. A cushioning device is disposed between the board and the shaft for preventing the board from striking onto the shaft and for allowing the riders to more comfortably ride the scooter. One or more poles are secured between the board and the shaft, and one or more springs are engaged between the board and the shaft for cushioning the board.

### BACKGROUND OF THE INVENTION

1. Field of the Invention

The present invention relates to a scooter, and more particularly to a scooter including a spring cushioning device for cushioning the vibrations or the shocks transmitted to the wheels of the scooter.

2. Description of the Prior Art

Typical scooters comprise a board for supporting the users or the riders of the scooter, one or more wheels attached to the front portion of the board, one or more wheels attached to the rear portion of the board, and a handle attached to the board for maneuvering the scooter. No cushioning devices have been provided for cushioning the scooter, such that the vibrations or the shocks that are transmitted to the wheels of the scooter may be directly transmitted to the riders, such that the scooter riders may not feel comfortable while riding the scooters.

The present invention has arisen to mitigate and/or obviate the afore-described disadvantages of the conventional scooters.

### SUMMARY OF THE INVENTION

The primary objective of the present invention is to provide a scooter including a spring cushioning device for cushioning the vibrations or the shocks transmitted to the wheels of the scooter and for allowing the users to comfortably riding the scooter.

In accordance with one aspect of the invention, there is provided a scooter comprising a board including a rear portion having at least one rear wheel attached thereto, and including a front portion, a shaft rotatably secured to the front portion of the board, at least one front wheel rotatably secured to the shaft, and a cushioning means provided between the front portion of the board and the shaft for cushioning the board and for preventing the board from striking onto the shaft.

One or more arms are further provided and each includes a first end rotatably secured to the front portion of the board with a pivot axle, and each includes a second end secured to the shaft, for allowing the shaft to be rotated relative to the board about the pivot axle.

The cushioning means includes at least one pole secured between the front portion of the board and the shaft, and at least one spring engaged on the pole and engaged between the front portion of the board and the shaft.

One or more second springs are further provided and engaged on the pole and engaged between the pole and the shaft.

One or more brackets are further provided and each includes a first end rotatably attached to the shaft and each includes a second end, the front wheel is rotatably secured to a first of the brackets with a pivot spindle, a bar includes two ends pivotally secured between the second ends of the brackets, and two cushioning pads are engaged between the bar and the brackets respectively.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a scooter in accordance with the present invention;

FIG. 2 is an exploded view of the scooter;

FIG. 3 is a partial cross sectional view taken along lines 3-3 of FIG. 1; and

FIG. 4 is a partial top plane schematic view illustrating the operation of the spring cushioning device of the scooter.

### DETAILED DESCRIPTION OF THE PREFERRED EMBODIMENT

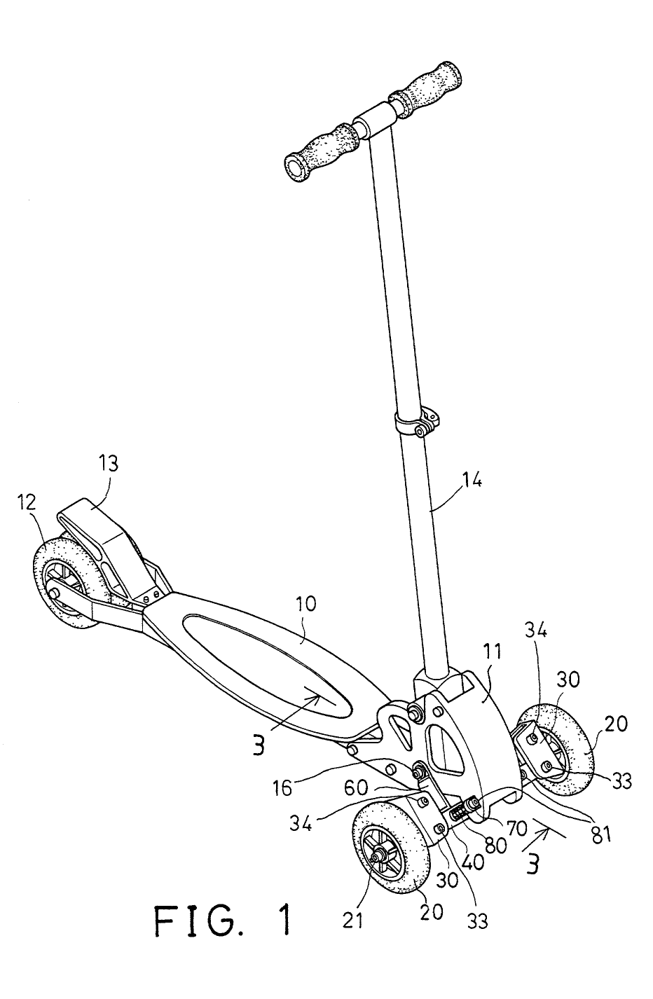

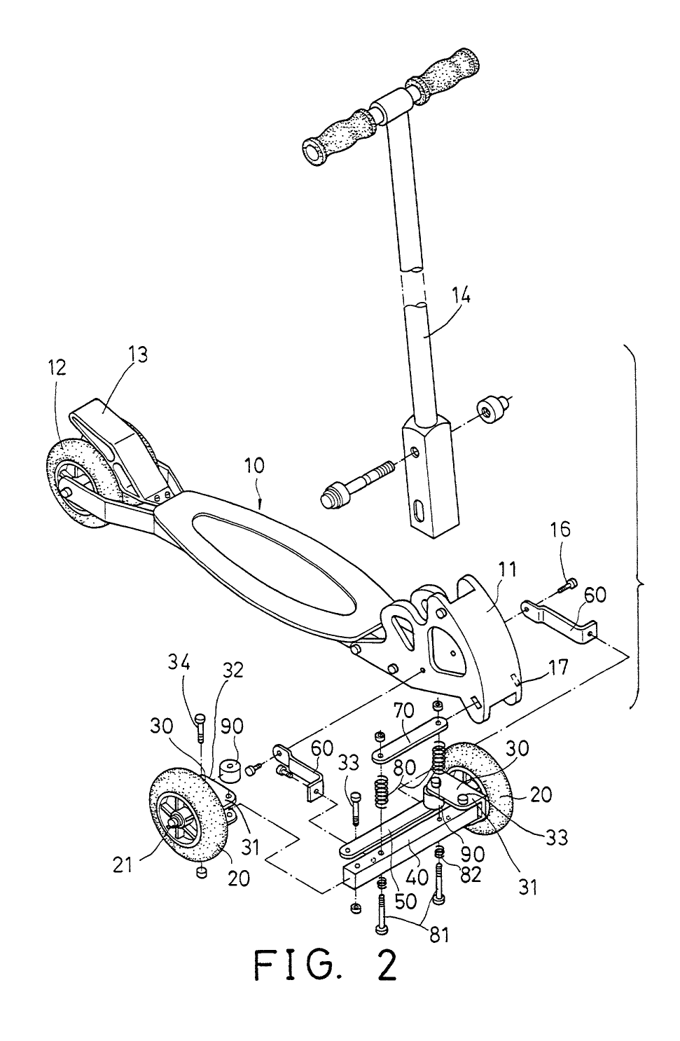

Referring to the drawings, and initially to FIGS. 1-3, a scooter in accordance with the present invention comprises a board 10 including a handle 14 having a lower portion attached to the front portion 11 thereof with an axle 16 or one or more fasteners, and including one or more wheels 12 attached to the rear portion thereof, and including a brake device 13 for engaging with the wheels 12 and for braking the scooter. The handle 14 may be rotated relative to the board 10 and may be folded or moved between an open working position and a folded storing position. The board 10 includes a beam 70 engaged through a channel 17 that is formed in the front portion 11 of the board 10 and preferably secured to the board 10.

Two brackets 30 each includes a front portion 31 and a rear portion 32 and a middle portion. Two wheels 20 are rotatably secured to the middle portions of the brackets 30 respectively with a spindle 21. A shaft 40 is secured between the front portions 31 of the brackets 30 and includes two ends pivotal ly or rotatably secured to the front portions 31 of the brackets 30 with pivot rods 33 respectively, such that the brackets 30 are rotatably relative to the shaft 40 about the pivot rods 33 respectively.

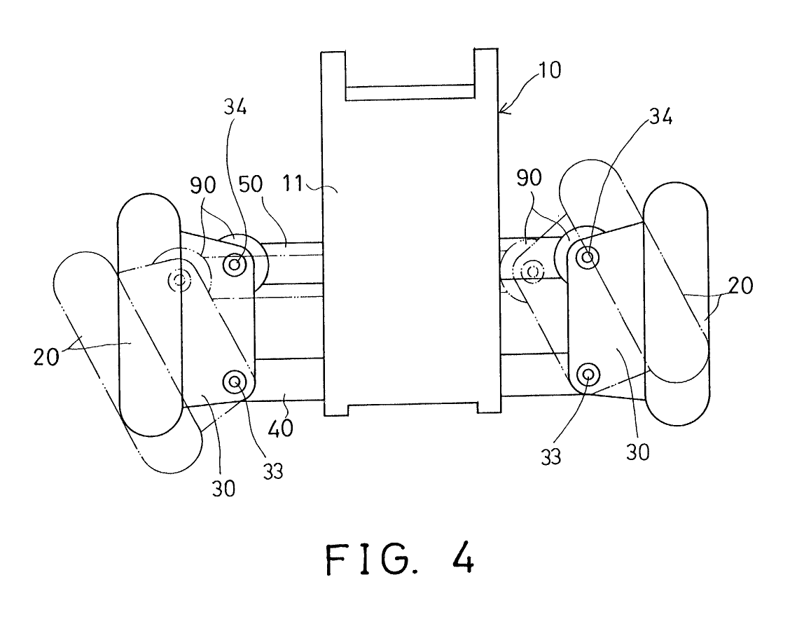

A bar 50 has two ends pivotally or rotatably secured to the rear portions 32 of the brackets 30 with pivot pins 34 respectively, such that the brackets 30 are also rotatably relative to the bar 50 about the pivot pins 34 respectively. Two cushioning pads 90 are engaged on the pivot pins 34 respectively and engaged between the brackets 30 and the bar 50 respectively for applying a spring-biasing force against the brackets 30 and the bar 50. The cushioning pads 90 may be engaged with the front portion 11 of the board 10 (FIG. 4) for cushioning the striking of the boards 30 onto the front portion of the board 10 and for preventing the board 10 from being stricken or damaged by the brackets 30 when the brackets 30 are rotated relative to the board 10.

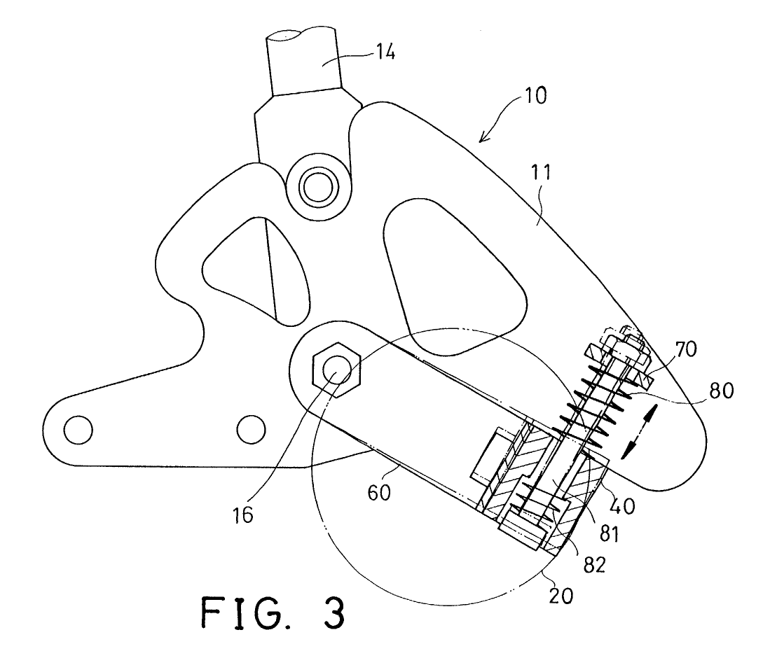

Two arms 60 have a rear end rotatably or pivotally secured to the board 10 with the axle 16 and have a front end secured to the shaft 40, such that the shaft 40 is rotatable relative to the board 10 about the pivot axle 16, and such that the front ends of the arms 60 and the shaft 40 may be moved toward and away from the front portion 11 of the board 10, best shown in FIG. 3. Two poles 81 are engaged or secured between the shaft 40 and the beam 70, and two springs 80 are engaged on the poles 81 and engaged between the beam 70 and the shaft 40 for applying a spring cushioning force against the shaft 40 and for biasing the shaft 40 and the wheels 20 downward away from the front portion 11 of the board 10. Two further springs 82 are engaged between the poles 81 and the shaft 40 for applying a spring cushioning force against the shaft 40 and for cushioning the poles 81 and for preventing the poles 81 from striking onto the shaft 40.

In operation, as shown in FIG. 3, while riding the scooter, the shaft 40 and the arms 60 and thus the wheels 20 may rotate relative to the front portion 11 of the board 10 and may be moved away from and toward the front portion 11 of the board 10 against the springs 80, such that the front portion 11 of the board 10 may be resiliently supported on the wheels 20 with the springs 80, and such that the front portion 11 of the board 10 may be prevented from striking onto the shaft 40, and such that the riders may ride the scooter with more comfortableness. As shown in FIG. 4, the brackets 30 and thus the wheels 20 may be rotated relative to the shaft 40 about the pivot rods 33 for steering purposes. The cushioning pads 90 may be engaged with the front portion 11 of the board 10 for preventing the board 10 from being stricken or damaged by the brackets 30 when the brackets 30 are rotated relative to the board 10.

Accordingly, the scooter in accordance with the present invention includes a spring cushioning device for cushioning the vibrations or the shocks transmitted to the wheels of the scooter and for allowing the users to comfortably riding the scooter.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A scooter comprising:
a board,
at least one wheel, and
a cushioning means provided between said board and said at least one wheel for cushioning said board and for preventing said board from striking onto said at least one wheel.

2. A scooter comprising:
a board including a rear portion having at least one rear wheel attached thereto, and including a front portion,
at least one front wheel provided in said front portion of said board, and
a cushioning means provided between said front portion of said board and said at least one front wheel for cushioning said board and for preventing said front portion of said board from striking onto said at least one front wheel.

3. The scooter according to claim 2 further comprising a shaft rotatably secured to said front portion of said board for supporting said at least one front wheel, said cushioning means being provided between said front portion of said board and said shaft.

4. The scooter according to claim 3 further comprising at least one arm including a first end rotatably secured to said front portion of said board with a pivot axle, and including a second end secured to said shaft, for allowing said shaft to be rotated relative to said board about said pivot axle.

5. The scooter according to claim 3, wherein said cushioning means includes at least one pole secured between said front portion of said board and said shaft, and at least one spring engaged on said at least one pole and engaged between said front portion of said board and said shaft.

6. The scooter according to claim 5 further comprising at least one second spring engaged on said at least one pole and engaged between said at least one pole and said shaft.

7. The scooter according to claim 3 further comprising at least one bracket attached to said shaft, said at least one front wheel being rotatably secured to said at least one bracket with a pivot spindle.

8. The scooter according to claim 7, wherein said at least one bracket includes a first end pivotally secured to said shaft and includes a second end, said scooter further includes a bar having an end portion pivotally secured to said second end of said at least one bracket, and a cushioning pad engaged between said bar and said at least one bracket.

9. A scooter comprising:
a board including a rear portion having at least one rear wheel attached thereto, and including a front portion,
a shaft rotatably secured to said front portion of said board,
at least one front wheel rotatably secured to said shaft, and
a cushioning means provided between said front portion of said board and said shaft for cushioning said board and for preventing said board from striking onto said shaft.

10. The scooter according to claim 9 further comprising at least one arm including a first end rotatably secured to said front portion of said board with a pivot axle, and including a second end secured to said shaft, for allowing said shaft to be rotated relative to said board about said pivot axle.

11. The scooter according to claim 9, wherein said cushioning means includes at least one pole secured between said front portion of said board and said shaft, and at least one spring engaged on said at least one pole and engaged between said front portion of said board and said shaft.

12. The scooter according to claim 11 further comprising at least one second spring engaged on said at least one pole and engaged between said at least one pole and said shaft.

13. The scooter according to claim 9 further comprising at least one bracket attached to said shaft, said at least one front wheel being rotatably secured to said at least one bracket with a pivot spindle.

14. The scooter according to claim 13, wherein said at least one bracket includes a first end pivotally secured to said shaft and includes a second end, said scooter further includes a bar having an end portion pivotally secured to said second end of said at least one bracket, and a cushioning pad engaged between said bar and said at least one bracket.

15. The scooter according to claim 9 further comprising two brackets each including a first end rotatably attached to said shaft and each including a second end, said at least one front wheel being rotatably secured to a first of said brackets with a pivot spindle, a bar including two ends pivotally secured between said second ends of said brackets, and two cushioning pads engaged between said bar and said brackets respectively.
